(19) United States
(12) Patent Application Publication
(10) Pub. No.: US 2017/0088798 A1
(43) Pub. Date: Mar. 30, 2017

(54) CLEANING AND/OR TREATMENT COMPOSITIONS

(71) Applicant: The Procter & Gamble Company, Cincinnati, OH (US)

(72) Inventors: Giulia Ottavia BIANCHETTI, Brussels (BE); Jeremy Michael CELLIERS, Geneva (CH); Claudia (NMN) CRESTINI, Rome (IT)

(21) Appl. No.: 15/375,257

(22) Filed: Dec. 12, 2016

Related U.S. Application Data
(63) Continuation of application No. 15/001,427, filed on Jan. 20, 2016.
(60) Provisional application No. 62/113,548, filed on Feb. 9, 2015.
(60) Provisional application No. 62/154,868, filed on Apr. 30, 2015.

(51) Int. Cl. C11D 3/00; C11D 3/20; C11D 3/37; C11D 3/382; C11D 11/00

(52) U.S. Cl. CPC C11D 3/0068; C11D 3/382; C11D 11/0017; C11D 3/373; C11D 3/2075

(57) ABSTRACT

The invention relates to cleaning and/or treatment compositions comprising tannins and methods of making and using same. Such cleaning and/or treatment compositions can mitigate/neutralize malodors without imparting color to an article that is treated with such cleaning and/or treatment composite. In addition, such the appearance of such compositions is not adversely impacted by the tannins that they contain.

### FIELD OF INVENTION

The invention relates to cleaning and/or treatment compositions comprising tannins and methods of making and using same.

### BACKGROUND OF THE INVENTION

Manufacturers of unscented or scented products rely on malodor reduction ingredients or other technologies (e.g. filters) to reduce malodors. However, effectively controlling malodors, for example, amine-based malodors (e.g. fish and urine), thiol and sulfide-based malodors (e.g. garlic and onion), C₂-C₁₂ carboxylic acid based malodors (e.g. body and pet odor), indole based malodors (e.g. fecal and bad breath), short chain fatty aldehyde based malodors (e.g. grease) and geosmin based malodors (e.g. mold/mildew) may be difficult, and the time required for a product to noticeably reduce malodors may create consumer doubt as to the product's efficacy on malodors. Often times, manufacturers incorporate additional perfumes to help mask these difficult malodors.

To tackle malodor the typical approach is to cover up the malodor with a stronger scent thus masking the malodor. But the malodor masking is only temporary and malodor may re-bloom upon usage of the material treated with the masking perfume. Surprisingly the Applicants have found that tannins can be used at low levels to control malodor via applications that include through the wash, spray on and dryer added applications. Without wishing to be bound by theory, the Applicants believe that tannins entrapmalodor, thereby preventing their release in the headspace. The Applicants also believe that tannins prevent the formation of additional malodor species thanks to their anti-oxidant properties.

Tannins are polyphenolic compounds that are found in products such as red wine. Materials like tannins are generally avoided in through the wash, spray on and dryer added applications as they can stain fabrics. With most benefit agents, as the level of an active is increased the benefit of the active increases. Here, Applicants recognized that at low levels tannins can mitigate/neutralize malodors without imparting color to a cleaning and/or treatment composition and the article that is treated with such cleaning and/or treatment composition and that such malodor mitigation/neutralization benefits are best achieved at low tannins level rather than higher level.

### SUMMARY OF THE INVENTION

The invention relates to cleaning and/or treatment compositions comprising tannins and methods of making and using same. Such cleaning and/or treatment compositions can mitigate/neutralize malodors without imparting color to an article that is treated with such cleaning and/or treatment composite. In addition, the appearance of such compositions is not adversely impacted by the tannins that they contain.

### DETAILED DESCRIPTION OF THE INVENTION

### Definitions

As used herein, the term “cleaning and/or treatment composition” is a subset of consumer products that includes, unless otherwise indicated, beauty care, fabric & home care products. Such products include, but are not limited to, products for treating hair (human, dog, and/or cat), including, bleaching, coloring, dyeing, conditioning, shampooing, styling; deodorants and antiperspirants; personal cleansing; cosmetics; skin care including application of creams, lotions, and other topically applied products for consumer use including fine fragrances; and shaving products, products for treating fabrics, hard surfaces and any other surfaces in the area of fabric and home care, including: air care including air fresheners and scent delivery systems, car care, dishwashing, fabric conditioning (including softening and/or freshening), laundry detergency, laundry and rinse additive and/or care, hard surface cleaning and/or treatment including floor and toilet bowl cleaners, granular or powder-form all-purpose or “heavy-duty” washing agents, especially cleaning detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, including antibacterial hand-wash types, cleaning bars, mouthwashes, denture cleaners, dentifrice, car or carpet shampoos, bathroom cleaners including toilet bowl cleaners; hair shampoos and hair-rinses; shower gels, fine fragrances and foam baths and metal cleaners; as well as cleaning auxiliaries such as bleach additives and “stain-stick” or pre-treat types, substrate-laden products such as dryer added sheets, dry and wetted wipes and pads, nonwoven substrates, and sponges; as well as sprays and mists all for consumer or/and institutional use; and/or methods relating to oral care including toothpastes, tooth gels, tooth rinses, denture adhesives, tooth whitening.

As used herein, the term “fabric and/or hard surface cleaning and/or treatment composition” is a subset of cleaning and treatment compositions that includes, unless otherwise indicated, granular or powder-form all-purpose or “heavy-duty” washing agents, especially cleaning detergents; liquid, gel or paste-form all-purpose washing agents, especially the so-called heavy-duty liquid types; liquid fine-fabric detergents; hand dishwashing agents or light duty dishwashing agents, especially those of the high-foaming type; machine dishwashing agents, including the various tablet, granular, liquid and rinse-aid types for household and institutional use; liquid cleaning and disinfecting agents, including antibacterial hand-wash types, cleaning bars, car or carpet shampoos, bathroom cleaners including toilet bowl cleaners; and metal cleaners, fabric conditioning products including softening and/or freshening that may be in liquid, solid and/or dryer sheet form; as well as cleaning auxiliaries such as bleach additives and “stain-stick” or pre-treat types, substrate-laden products such as dryer added sheets, dry and wetted wipes and pads, nonwoven substrates, and sponges; as well as sprays and mists. All of such products which are applicable may be in standard, concentrated or even highly concentrated form even to the extent that such products may in certain aspect be non-aqueous.

As used herein, articles such as “a” and “an” when used in a claim, are understood to mean one or more of what is claimed or described.

As used herein, the terms “include”, “includes” and “including” are meant to be non-limiting.

As used herein, the term “solid” includes granular, powder, bar and tablet product forms.

As used herein, the term “fluid” includes liquid, gel, paste and gas product forms.

As used herein, the term “situs” includes paper products, fabrics, garments, hard surfaces, hair and skin.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Compositions

A cleaning and/or treatment product comprising, based on total cleaning and/or treatment product weight, from about 0.0001% to about 1.5%, preferably from about 0.001% to about 0.5%, of a tannin and a cleaning and/or treatment adjunct preferably said treatment adjunct comprises a material selected from the group consisting of surfactants, builders, fatty acids, perfumes, perfume delivery systems, silicone, preferably said material is selected from the group consisting of surfactants, builders, perfumes, perfume delivery systems is disclosed.

Tannins are polyphenolic secondary metabolites of higher plants, and are either galloyl esters and their derivatives, in which galloyl moieties or their derivatives are attached to a variety of polyol-, catechin- and triterpenoid cores (gallotannis, ellagitannins and complex tannins), or they are oligomeric and polymeric proanthocyanidis that can possess interflavanyl coupling and substitution patterns (condensed tannins). More details on the classification of tannins can be found in K. Khanbabaee, T. van Ree, Tannins: Classification and Definition, The Royal Society of Chemistry 2001, pages 641-649.

Gallotannins are all those tannins in which galloyl units are bound to diverse polyol-, catechin- or triterpenoid units.

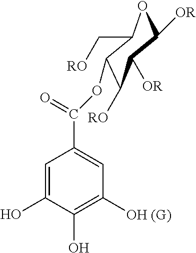

Ellagitannins are those tannins in which at least two galloyl units are C—C coupled to each other, and do not contain a glycosidically linked catechin unit.

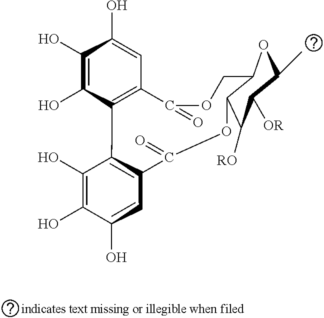

Complex tannins are tannins in which a catechin unit is bound glycosidically to a gallotannin or an ellagitannin unit.

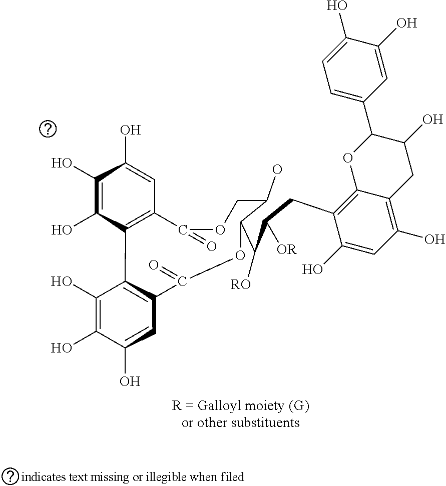

Condensed tannins are all oligomeric and polymeric proanthocyanidins formed by linkage of C-4 of one catechin with C-8 or C-6 of the next monomeric catechin.

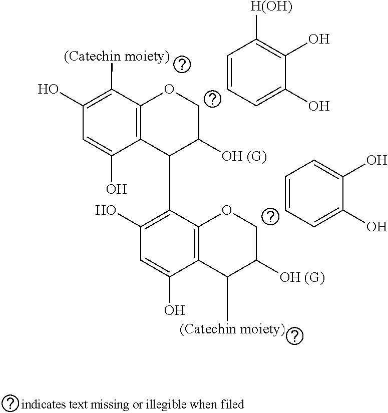

TABLE 1
provides classes of tannins more widely found in common higher plants.

| | | | SPECIES | STRUCTURE |
|---|---|---|---|---|
| | | | (example | (tannins classes present at |
| COMMON | | | of species | higher percentage in the |
| NAME | FAMILY | GENUS | studied) | plant extract) |
| Nutgall tree | Anacardiacee | Rhus | | Gallotannins |
| (sumac) | | | | Ellagitannins |
| Willow leaf | Anacardiacee | Shinopsis | balansae | Condensed |
| Red | Anacardiacee | Shinopsis | lorentzii | Condensed |
| Quebracho | | | | |
| Grape seeds | Vitaceae | Vitis | vinifera | Condensed |
| Mimosa | Fabaceae | acacia | mollissima | Condensed |
| bark | Mimosoideae | | | |
| (black | Fabaceae | Acacia | mearnsii | Condensed |
| wattle) | Mimosoideae | | | |
| Quechua | Fabaceae | Caesalpinia sp. | spinosa | Gallotannins |
| | | | | Ellagitannins |
| | Fabaceae | Sesbania | | Condensed |
| trefoil | Fabaceae | Lotus | | Condensed |
| sainfoin | Fabaceae | Onobrychis sp. | | Condensed |
| | Fabaceae | Vicia | faba | Condensed |
| oak | Fagaceae | Quercus sp. | | Gallotannins |
| | | | | Ellagitannins |
| chestnut | Fagaceae | Castanea | sativa | Ellagitannins |
| | Fagaceae | Lithocarpus | | Condensed |
| | Beech | glaber sp. | | |
| oak | Fagaceae | Quercus | | Gallotannins |
| | | | | Ellagitannins |
| maple | Sapindaceae | Acer | | Gallotannins |
| | | | | Ellagitannins |
| Pine bark | Pinaceae | Pinus | | Condensed |
| | Pinoidaea | | | |
| Spruce bark | Pinaceae | Picea | | Condensed |
| | | Sorghum | | Condensed |
| | Rhizophoraceae | mangrove | | Condensed |
| | Myrtaceae | Eucalyptus | | Ellagitannins |
| | | | | Gallotannins |
| | | | | Condensed |
| Myrtan or | Myrtaceae | Eucalyptus | redunca | Condensed |
| black | | | | |
| marlock | | | | |
| Myrtle | Myrtaceae | Mirtus | | Condensed |
| birch | Betulaceae | Betula | | Gallotannins |
| | | | | Ellagitannins |
| myrabolan | Combretaceae | Terminalia | chebula | Ellagitannins |
| | Rosaceae | Prunus sp. | | Condensed |
| | Rosaceae | Malus sp. | | Condensed |
| betel | Arecaceae | Areca | catechu | Condensed |
| | Burseraceae | Commiphora | | Condensed |
| | Burseraceae | Angolensissp. | | Condensed |
| | Burseraceae | Canarium sp. | | Condensed |
| Persommon | Ebenaceae | Diospyros | | Complex |

Preferably said cleaning and/or treatment product comprising, based on total cleaning and/or treatment product weight, from about 0.0001% to about 1.5%, preferably from about 0.001% to about 0.5%, of a tannin selected from the group consisting of gallotannins, ellagitannins, condensed tannins, complex tannins and mixtures thereof.

Preferably gallotannins are extracted from sumac galls, Aleppo oak galls, or sumac leaves, more preferably said gallotannins are selected from the group consisting of tannins extracted from Aleppo oak galls.

Preferably ellagitannins are extracted from chestnut bark, and chestnut wood, more preferably said ellagitannins are selected from the group consisting of tannins extracted from chestnut bark.

Preferably condensed tannins are selected from the group consisting of tannins extracted from bark pine, querbracho, mimosa bark, spruce bark, grape seeds, more preferably said condensed tannins are selected from the group consisting of tannins extracted from bark pine and querbracho.

Preferably complex tannins are selected from the group consisting of tannins extracted from persimmon and tea leaves.

Preferably said tannin comprises a tannin selected from the group consisting of condensed tannins, more preferably said tannins are selected from the group consisting of tannins extracted from bark pine or querbracho.

Preferably said tannin comprises a tannin selected from the group consisting of condensed tannins, more preferably said tannins are selected from the group consisting of tannins extracted from bark pine or querbracho.

Preferably said a cleaning and/or treatment product comprises, based on total cleaning and/or treatment product weight, from about 1% to about 97%, preferably from about 5% to about 90%, more preferably from about 8% to about 80% water.

In one aspect, said composition contains, based on total composition weight, 0.05 wt % to 50 wt %, advantageously 1 to 40 wt %, 3 to 30 wt % or 5 wt % to 20 wt % surfactant selected from the groups of anionic surfactants, nonionic surfactants, cationic, zwitterionic and/or amphoteric surfactants.

In one aspect, said composition contains, based on total composition weight, a nonionic surfactant, in one aspect, said composition contains, based on total composition weight, from 0.01 to 25 wt %, from 1 to 20 wt %, or from 3 to 15 wt %, nonionic surfactant.

In one aspect, said composition contains, based on total composition weight, from 0.1 to 80 wt %, 1 to 60 wt %, or 5 to 50 wt % builders.

In one aspect, said composition contains a soluble builder system, in one aspect, said soluble builder system comprises soda, silicate, citrate and/or polycarboxylates.

In one aspect, said composition contains a perfume and a perfume delivery system. This perfume delivery system comprises a material selected from the group consisting of microcapsules, a polymer assisted delivery system; a molecule-assisted delivery system; a fiber-assisted delivery system; a cyclodextrin delivery system; a starch encapsulated accord; and/or an inorganic carrier delivery system.

In one aspect, said perfume microcapsule comprises a material selected from the group consisting of melamine-formaldehyde polymers, melamine-urea polymers, polyurea, polyurethane, polyacrylate, polymethylmethacylate and polyacrylate esters.

In one aspect, said microcapsules contain aromatic substances.

In one aspect, said benefit agent delivery particles may have any combination of the aforementioned parameters as listed in the aforementioned aspects.

In one aspect, a method for manufacturing a liquid composition, comprising stirring the tannin in a liquid composition or by continuously adding said tannin into a liquid composition and mixing the ingredients by means of static mixing elements, in one aspect, the tannin is mixed with surfactant beforehand is disclosed.

In one aspect, a method for manufacturing a solid composition, selected from the group consisting of

(a) mixing a tannin into a solid composition;

(b) mixing said tannin in granulated or supported form into a solid composition; or

(c) mixing said tannin in dried form into the solid composition

is disclosed.

The tannins are stable within the detergent or cleaning agent matrix. During use of the detergent or cleaning agent, for example when washing laundry, the tannins are deposited on the item to be cleaned and provide malodor management benefits.

The tannins that can be used according to the invention are contained in the detergent or cleaning agent in amounts of preferably 0.0001 to 1.5 wt %, advantageously 0.001 to 0.5%, based on the product as a whole.

The tannins that can be used according to the invention are introduced into the detergent or cleaning agent according to the invention in particular in the form of powder (100% active) or as a water-solvent solution for example: water:ethanol:ethylene glycol=1:1:1 solution. The detergent or cleaning agent according to the invention contains, in addition to the described tannins, other ingredients, namely, at a minimum, surfactants and/or builders.

Described in greater detail below are other possible ingredients of the detergents or cleaning agents. However, it should first be made clear that for the purposes of this invention, the term “detergent” comprises in particular detergents or cleaning agents as well as after-treatment agents (such as, preferably, fabric softeners, fragrant rinses, conditioning sheets for use in clothes dryers, hygiene rinses, etc.). Fabric detergent is the term for the formulations needed for washing fabrics, for example present in the form of powders, granules, pearls, tablets, pastes, gels, sheets, portions or liquids, which are preferably used in aqueous solutions, in particular in washing machines. Fabric softeners are fabric after-treatment agents for the treatment of fabrics and preferably contain active substances that make the treated fabric feel softer, in particular cationic active substances (preferably cationic surfactants, for example quaternary ammonium compounds), fatty acid derivatives and/or silicone oils. Fragrant rinses are fabric after-treatment agents containing perfume to treat fabrics; they give the fabrics a particularly appealing fragrance. Conditioning sheets for use in clothes dryers are nonwovens or sheets containing active substances (in particular fabric softeners). Hygiene rinses are fabric after-treatment agents for treating fabrics that contain at least one antimicrobial active substance, for example quaternary ammonium compounds such as, for example, benzalkonium chloride, and help reduce the laundry's bacterial load. The term “cleaning agent” comprises all cleaners for hard or soft surfaces, but preferably hard surfaces, in particular dishwashing detergents (including dishwashing liquids and machine dishwashing detergents), all-purpose cleaners, toilet-bowl cleaners, bathroom cleaners and glass cleaners. All detergents or cleaning agents can be, for example, in the form of powders, granules, pearls, tablets, pastes, gels, sheets, portions or liquids.

They can be single-phase or multi-phase. They can also be present in single-serve packages, so-called “pouches,” wherein in one variant, the microcapsules are embedded in the film materials used for the pouch, for example PVA.

The term “detergent” also comprises hair care or personal care cleaning compositions as well as after-treatment agents (such as, preferably, hair rinse-off or leave-on conditioners)

The detergents or cleaning agents according to the invention contain, in addition to tannins, surfactants and/or builders as necessary components.

Possible surfactants include, in particular, anionic surfactants, nonionic surfactants, cationic surfactants, zwitterionic surfactants and/or amphoteric surfactants, However, it is particularly preferred if the detergent or cleaning agent according to the invention contains anionic, nonionic and/or cationic surfactants. Particularly advantageous is the use of a mixture of anionic and nonionic surfactants. The detergent or cleaning agent according to the invention preferably contains 0.05 wt % to 50 wt %, advantageously 1 to 40 wt %, more advantageously 3 to 30 wt %, and in particular 5 wt % to 20 wt % surfactant(s), in particular from the groups of anionic surfactants, nonionic surfactants, cationic, zwitterionic and/or amphoteric surfactants. This corresponds to a preferred embodiment of the invention and enables optimum cleaning performance.

It is particularly preferred if the detergent or cleaning agent according to the invention contains anionic surfactant, advantageously in amounts from 0.1 to 25 wt %, more advantageously 1 to 20 wt %, and in particular in amounts of 3 to 15 wt %, based on the product as a whole. This corresponds to a preferred embodiment of the invention and enables particularly advantageous cleaning performance. One particularly suitable anionic surfactant is alkyl benzene sulfonate, preferably linear alkyl benzene sulfonate (LAS). If the detergent or cleaning agent according to the invention contains alkyl benzene sulfonate, advantageously in amounts of 0.1 to 25 wt %, more advantageously 1 to 20 wt %, and in particular in amounts of 3 to 15 wt %, based on the product as a whole, this constitutes a preferred embodiment of the invention.

Other particularly suitable anionic surfactants are alkyl sulfates, in particular fatty alcohol sulfates (FAS) such as, for example, C₁₂-C₁₈ fatty alcohol sulfate. C₈-C₁₈ alkyl sulfates can preferably be used; particularly preferred are C₁₃ alkyl sulfate and C₁₃-C₁₅ alkyl sulfate and C₁₃-C₁₇ alkyl sulfate, advantageously branched, in particular alkyl-branched C₁₃-C₁₇ alkyl sulfate. Particularly suitable fatty alcohol sulfates can be derived from lauryl and myristyl alcohol; i.e. fatty alcohol sulfates containing 12 or 14 carbon atoms. Long-chained FAS types (C₁₆ to C₁₈) are very suitable for washing laundry at higher temperatures. Other preferred anionic surfactants that can be used include alkane sulfonates (e.g. secondary C₁₃-C₁₈ alkane sulfonate), methyl ester sulfonates (e.g. C₁₂-C₁₈ methyl ester sulfonate) and α-olefin sulfonates (e.g. C₁₄-C₁₈ olefin sulfonate) and alkyl ether sulfates (e.g. C₁₂-C₁₄ fatty alcohol-2EO ether sulfate) and/or soaps. Other suitable anionic surfactants will be described further below. However, particularly suitable are FAS and/or LAS.

The anionic surfactants, including the soaps, can be in the form of their sodium, potassium or ammonium salts, as well as soluble salts of organic bases such as mono-, di- or triethanolamine. Preferably, the anionic surfactants are present in the form of their sodium or potassium salts, in particular in the form of sodium salts.

It is particularly preferred if the detergent or cleaning agent according to the invention contains nonionic surfactants, advantageously in amounts of 3 to 15 wt %, more advantageously 1 to 20 wt %, and in particular in amounts of 3 to 15 wt %, based on the product as a whole. This corresponds to one preferred embodiment of the invention. Particularly preferred is the use of alkyl polyglycol ethers, in particular in combination with anionic surfactant, such as, preferably, LAS. Other suitable nonionic surfactants are alkyl phenol polyglycol ether (APEO), (ethoxylated) sorbitan fatty acid ester (sorbitans), alkyl polyglucosides (APG), fatty acid glucamides, fatty acid ethoxylates, amine oxides, ethylene oxide propylene oxide block polymers, polyglycerol fatty acid ester, and/or fatty acid alkanol amides. Other suitable nonionic surfactants will be described further below. Sugar-based nonionic surfactants, such as, in particular, APG, are particularly preferred.

For the purposes of the invention, builders include in particular zeolites, polycarboxylates, citrates (such as, for example, sodium citrate, soda, sodium hydrogen carbonate, phosphates, sodium silicates (soluble glass), phosphonates, alkaline amorphous disilicates, and crystalline layered silicates. Builders are contained in the detergent or cleaning agent according to the invention preferably in amounts of 0.1 to 80 wt %, advantageously 1 to 60 wt %, and more advantageously 5 to 50 wt %. In addition, it is most particularly preferred that the detergent or cleaning agent according to the invention contain a builder system (i.e. at least two substances having a builder effect), preferably a builder system containing zeolite, preferably comprising zeolite in amounts >1 wt %, advantageously >5 wt %, more advantageously >10 wt %, in particular ≧15 wt %, wt % based on the product as a whole. A useful maximum amount can be 40 wt %, 30 wt % or 20 wt %, based on the product as a whole. This corresponds to a preferred embodiment of the invention. A combination of zeolite and soda is preferred.

It is also particularly preferred if the detergent or cleaning agent according to the invention contains a soluble builder system, preferably comprising soda, silicate, citrate and/or polycarboxylates, advantageously in amounts of 0.1 to 50 wt %, based on the product as a whole. This corresponds to a preferred embodiment of the invention. If such a soluble builder system is contained in the product, it is most preferable if the product contains only minor amounts of insoluble builders, such as, in particular, zeolite, for example <5 wt % to 0.1 wt %, and in particular, if the product in such cases contains no insoluble builder at all.

It is also possible for the detergent or cleaning agent according to the invention to contain phosphates. Phosphate is preferably contained in amounts of 1 to 40 wt %, in particular 5 to 30 wt %, based on the product as a whole. However, according to another preferred embodiment, the detergent or cleaning agent according to the invention is free of phosphates.

The detergents or cleaning agents according to the invention, which, for example, can be present as, in particular, solids in powder form, in passivated particle form, as homogenous solutions or suspensions, can also in principle contain all known ingredients that are customary in such products. The products according to the invention can, as was already shown, contain in particular builder substances, surfactants, also bleaching agents, bleach activators, water-miscible organic solvents, enzymes, sequestering agents, electrolytes, pH regulators, and other additives such as optical brighteners, fluorescing agents, anti-redeposition agents, shrinkage blockers, anti-creasing agents, color-transfer inhibitors, antimicrobial active substances, germicides, fungicides, antioxidants, preservatives, corrosion inhibitors, glass corrosion inhibitors, disintegrating agents, static inhibitors, bitters, ironing aids, water-repellent and impregnating agents, swelling and anti-slip agents, neutral filling salts, as well as UV absorbers, foam regulators, as well as colorants and aromatic substances.

The detergents and cleaning agents according to the invention can additionally also contain so-called “free,” non-microencapsulated perfume oils (aromatic substances). This corresponds to a particularly preferred embodiment of the invention. The composition of these perfume oils can be the same as or different from the perfume oils to be encapsulated. Based on the detergent or cleaning agent as a whole, preferably 0.0001 to 15 wt %, advantageously 0.001 to 10 wt %, and in particular 0.01 to 5 wt % aromatic substances can be contained therein.

Another subject matter of the invention is a method for manufacturing a solid detergent or cleaning agent, characterized
a) by mixing a tannin into the remaining detergent or cleaning agent matrix, or b) by mixing the tannin in granulated or supported form into the remaining detergent or cleaning agent matrix, or
c) by mixing the tannin in dried form into the remaining detergent or cleaning agent matrix.

To manufacture products according to the invention with increased bulk weight, in particular ranging from 650 g/L to 950 g/L, a method having an extrusion step and granulation are preferred.

To manufacture products according to the invention in tablet form, which can be single-phase or multiphase, monochromatic or polychromatic, and which can in particular consist of one layer or of several (in particular two) layers, preferably one starts by mixing all the components—if necessary one layer at a time—together in a mixer and pressing the mixture by means of conventional tablet presses, for example eccentric presses or rotary presses. In particular in the case of multi-layered tablets, it can be advantageous if at least one layer is pressed beforehand. In this way, unbreakable tablets are obtained without difficulty, which nevertheless dissolve sufficiently rapidly during use. The tablets can be of any shape, round, oval or square; intermediate forms are also possible. It is advantageous to round off corners and edges.

Liquid or pasty products according to the invention in the form of solutions containing typical solvents are generally manufactured by mixing ingredients that can be placed as a substance or solution in an automatic mixer. The microcapsules according to the invention can then be suspended, for example afterwards, in the otherwise “finished” composition.

Another subject matter of the invention is a method for manufacturing a liquid detergent or cleaning agent, characterized by stirring a tannin in the liquid detergent or cleaning agent matrix or by continuously adding the tannin into a liquid detergent or cleaning agent matrix and mixing the ingredients by means of static mixing elements; the tannin preferably having been mixed with surfactant beforehand.

When manufacturing the detergents or cleaning agents according to the invention, whether solid or liquid, it is generally advantageous to introduce the microcapsules to be introduced in the form of a water:ethanol:ethylen glycol=1:1:1 solution. For that purpose, it has proved very advantageous to mix the tannin dispersion with surfactant to stabilize it; the surfactant used being cationic, anionic and/or nonionic surfactant, preferably nonionic surfactant; ethoxylated oxo alcohol being particularly suitable.

Anionic surfactants are advantageously used in the method in amounts of 1 to 40 wt %, for example 2 to 30 wt % and in particular 3 to 20 wt %, to stabilize the dispersions (wt % based on the dispersion as a whole). Cationic surfactants can be advantageously used in amounts of 0.001 to 4 wt %, for example 0.01 to 3 wt % and in particular 0.1 to 2 wt %, to stabilize the dispersions (wt % based on the dispersion as a whole). Nonionic surfactants can be advantageously used in amounts of 0.01 to 20 wt %, for example 0.1 to 15 wt % and in particular 1 to 10 wt %, to stabilize the dispersions (wt % based on the dispersion as a whole). Suitable anionic surfactants include alkyl benzene sulfonates, preferably secondary C₁₀-C₁₃-n-alkyl benzene sulfonate, alkane sulfonates, methyl ester sulfonates, α-olefin sulfonates, alkyl sulfates, preferably fatty alcohol sulfate, alkyl ether sulfates, preferably fatty alcohol ether sulfate and sulfosuccinates. Suitable cationic surfactants include quaternary ammonium compounds, in particular quaternary ammonium compounds with one or two hydrophobic alkyl groups, quaternary phosphonium salts or tertiary sulfonium salts. Particularly preferred are so-called “esterquats.” Esterquat is the collective name for cationic surface-active compounds containing, preferably, two hydrophobic groups that are linked by ester bonds having a quaternized di(tri)ethanol amine or an analogous bond.

The use of nonionic surfactants to stabilize aqueous microcapsule dispersions has proved to be particularly advantageous. Advantageously usable compounds include in particular fatty alcohol ethoxylates, oxo alcohol ethoxylates, alkyl phenol polyglycol ethers, fatty acid ethoxylates, fatty amine ethoxylates, ethoxylated triacylglycerols and mixed ethers (polyethylene glycol ethers alkylated on both sides) as well as alkyl polyglucosides, sucrose esters, sorbitan esters, fatty acid glucamides and amine oxides.

However, the use of oxo alcohol ethoxylates is particularly advantageous in terms of the desired stabilization of the aqueous microcapsule dispersions. They enable the best results for the purposes of the invention. Preferred oxo alcohol ethoxylates are derived from oxo alcohols containing 9 to 15 carbon atoms, to which preferably 3 to 15 mol ethylene oxide are attached. One particularly preferred oxo alcohol ethoxylate for the purposes of the invention is C₁₃-C₁₅ oxo alcohol, to which 7 mol ethylene oxide are attached. A suitable commercial product is, for example, Lutensol® AO 7 from BASF. The use of oxo alcohol ethoxylates can completely repress the reversible flocculation.

The above-described stabilized tannin solutions are particularly advantageous for the manufacture of liquid detergents or cleaning agents. A method according to the invention, in which a liquid detergent or cleaning agent is mixed with a tannin solution, as described above, preferably by stirring the tannin solution into the detergent or cleaning agent matrix or by continuously adding it into a liquid detergent or cleaning agent and mixing the ingredients by means of static mixing elements, therefore is a preferred embodiment of the invention.

Stabilized tannin solutions are just as advantageous for the manufacture of solid detergents or cleaning agents. A method according to the invention, in which a solid detergent or cleaning agent is mixed with a tannin solution, as described above, for example by spraying the microcapsule dispersion onto the solid detergent or cleaning agent matrix or onto detergent or cleaning agent granules, therefore is a preferred embodiment of the invention.

Also particularly advantageous is a method for manufacturing a solid detergent or cleaning agent in which the tannin solution is granulated before it is mixed with a detergent or cleaning agent.

Another subject matter of the invention is a method for washing fabrics that uses a detergent or cleaning agent according to the invention (as described above), preferably in an automatic washing machine, wherein the washing temperature is ≦60° C., preferably ≦40° C.

Fabric after-treatment agents are preferred detergents or cleaning agents according to the invention. These fabric after-treatment agents, as well, contain the tannins used according to the invention, as well as surfactants and/or builders. They are preferably fabric softeners, i.e. fabric after-treatment agents, containing a cationic surfactant. Preferred contained cationic surfactants are esterquats. Esterquats are quaternary ammonium compounds containing, preferably, two hydrophobic groups, each of which contains an ester group as a so-called “predetermined breaking point” for easier biodegradability. The amount of cationic surfactant is preferably 2 to 80 wt %, advantageously 4 to 40 wt %, further preferred 6 to 20 wt % and in particular 8 to 15 wt % in each instance based on the product as a whole. Polyquaternized polymers (e.g. Luviquat® Care from BASF) and cationic chitin-based biopolymers and their derivatives, for example the polymer sold under the trade name Chitosan® (manufacturer: Cognis) can also be used as cationic surfactants.

Another subject matter of the invention is a fabric conditioning method that uses a fabric after-treatment agent according to the invention (as described above) in the rinse cycle of an automatic washing machine.

Another subject matter of the invention is a fabric drying method that uses a detergent or cleaning agent according to the invention in an automatic clothes dryer.

Another subject matter of the invention is a fabric conditioning method that uses a fabric after-treatment agent according to the invention in the form of a conditioning substrate in an automatic clothes dryer.

Another subject matter of the invention is the use of a fabric after-treatment agent according to the invention to condition fabrics.

For the purposes of the invention, preferred products are also cleaning agents, in particular cleansers for hard surfaces. These, as well, contain the tannins used according to the invention as well as surfactants and/or builders. Also included as cleaning additives in connection with automatic dishwasher detergents are, for the purposes of the invention, fragrance delivery systems that comprise a container and particles for the deodorizing and scenting of automatic dishwashers; said particles comprising microcapsules that contain aromatic substances.

If the cleaning agent according to the invention is chosen from the group consisting of dishwashing liquids, machine dishwashing detergents, toilet-bowl cleaners and bathroom cleaners, pipe cleaners and drain cleaners, universal or all-purpose cleaners, sanitary cleaners, oven cleaners and grill cleaners, metal cleaning agents, glass cleaners and window cleaners, cleaning aids, floor cleaners and special cleaning agents, this constitutes a preferred embodiment of the invention.

Another subject matter of the present invention is a particulate detergent or cleaning agent additive comprising the previously described tannins that can be used according to the invention, as well as surfactants and/or builders.

It has now been found that through the use of these tannins according to the invention, as described above, if they contain aromatic substance, a particularly advantageous olfactory impression (increased appeal/higher intensity/better longevity) can be obtained during washing or cleaning of surfaces, in particular of fabrics.

Another subject matter of the invention is the use of a detergent or cleaning agent according to the invention in a washing or cleaning process to deposit tannins on the treated objects (surfaces) in order to enable the targeted release of, preferably, liquid active substances such as, in particular, aromatic substances, on the objects by mechanical stimulus.

Another subject matter of the invention is the use of a detergent or cleaning agent according to the invention in a washing or cleaning process to deposit tannins on the treated objects (surfaces) in order to enable.

Adjunct Materials

The disclosed compositions may include additional adjunct ingredients that include: fabric hueing agents, bleach activators, surfactants, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, dyes, additional perfumes and perfume delivery systems, structure elasticizing agents, fabric softeners, carriers, hydrotropes, processing aids and/or pigments. Other embodiments of Applicants' compositions do not contain one or more of the following adjuncts materials: fabric hueing agents, bleach activators, surfactants, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, dyes, additional perfumes and perfume delivery systems, structure elasticizing agents, fabric softeners, carriers, hydrotropes, processing aids and/or pigments. The precise nature of these additional components, and levels of incorporation thereof, will depend on the physical form of the composition and the nature of the operation for which it is to be used. However, when one or more adjuncts are present, such one or more adjuncts may be present as detailed below. The following is a non-limiting list of suitable additional adjuncts.

Fabric Hueing Agents—The composition may comprise a fabric hueing agent (sometimes referred to as shading, bluing or whitening agents). Typically the hueing agent provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and mixtures thereof.

Suitable fabric hueing agents include dyes, dye-clay conjugates, and organic and inorganic pigments. Suitable dyes include small molecule dyes and polymeric dyes. Suitable small molecule dyes include small molecule dyes selected from the group consisting of dyes falling into the Colour Index (C.I.) classifications of Acid, Direct, Basic, Reactive or hydrolysed Reactive, Solvent or Disperse dyes for example that are classified as Blue, Violet, Red, Green or Black, and provide the desired shade either alone or in combination. In another aspect, suitable small molecule dyes include small molecule dyes selected from the group consisting of Colour Index (Society of Dyers and Colourists, Bradford, UK) numbers Direct Violet dyes such as 9, 35, 48, 51, 66, and 99, Direct Blue dyes such as 1, 71, 80 and 279, Acid Red dyes such as 17, 73, 52, 88 and 150, Acid Violet dyes such as 15, 17, 24, 43, 49 and 50, Acid Blue dyes such as 15, 17, 25, 29, 40, 45, 75, 80, 83, 90 and 113, Acid Black dyes such as 1, Basic Violet dyes such as 1, 3, 4, 10 and 35, Basic Blue dyes such as 3, 16, 22, 47, 66, 75 and 159, Disperse or Solvent dyes U.S. Pat. No. 8,268,016 B2, or dyes as disclosed in U.S. Pat. No. 7,208,459 B2, and mixtures thereof. In another aspect, suitable small molecule dyes include small molecule dyes selected from the group consisting of C. I. numbers Acid Violet 17, Acid Blue 80, Acid Violet 50, Direct Blue 71, Direct Violet 51, Direct Blue 1, Acid Red 88, Acid Red 150, Acid Blue 29, Acid Blue 113 or mixtures thereof.

Suitable polymeric dyes include polymeric dyes selected from the group consisting of polymers containing covalently bound (sometimes referred to as conjugated) chromogens, (dye-polymer conjugates), for example polymers with chromogens co-polymerized into the backbone of the polymer and mixtures thereof. Polymeric dyes include those described in U.S. Pat. No. 7,686,892 B2.

In another aspect, suitable polymeric dyes include polymeric dyes selected from the group consisting of fabric-substantive colorants sold under the name of Liquitint® (Milliken, Spartanburg, S.C., USA), dye-polymer conjugates formed from at least one reactive dye and a polymer selected from the group consisting of polymers comprising a moiety selected from the group consisting of a hydroxyl moiety, a primary amine moiety, a secondary amine moiety, a thiol moiety and mixtures thereof. In still another aspect, suitable polymeric dyes include polymeric dyes selected from the group consisting of Liquitint® Violet CT, carboxymethyl cellulose (CMC) covalently bound to a reactive blue, reactive violet or reactive red dye such as CMC conjugated with C.I. Reactive Blue 19, sold by Megazyme, Wicklow, Ireland under the product name AZO-CM-CELLULOSE, product code S-ACMC, alkoxylated triphenyl-methane polymeric colourants, alkoxylated thiophene polymeric colourants, and mixtures thereof.

Suitable dye clay conjugates include dye clay conjugates selected from the group comprising at least one cationic/basic dye and a smectite clay, and mixtures thereof. In another aspect, suitable dye clay conjugates include dye clay conjugates selected from the group consisting of one cationic/basic dye selected from the group consisting of C.I. Basic Yellow 1 through 108, C.I. Basic Orange 1 through 69, C.I. Basic Red 1 through 118, C.I. Basic Violet 1 through 51, C.I. Basic Blue 1 through 164, C.I. Basic Green 1 through 14, C.I. Basic Brown 1 through 23, CI Basic Black 1 through 11, and a clay selected from the group consisting of Montmorillonite clay, Hectorite clay, Saponite clay and mixtures thereof. In still another aspect, suitable dye clay conjugates include dye clay conjugates selected from the group consisting of: Montmorillonite Basic Blue B7 C.I. 42595 conjugate, Montmorillonite Basic Blue B9 C.I. 52015 conjugate, Montmorillonite Basic Violet V3 C.I. 42555 conjugate, Montmorillonite Basic Green G1 C.I. 42040 conjugate, Montmorillonite Basic Red RI C.I. 45160 conjugate, Montmorillonite C.I. Basic Black 2 conjugate, Hectorite Basic Blue B7 C.I. 42595 conjugate, Hectorite Basic Blue B9 C.I. 52015 conjugate, Hectorite Basic Violet V3 C.I. 42555 conjugate, Hectorite Basic Green G1 C.I. 42040 conjugate, Hectorite Basic Red R1 C.I. 45160 conjugate, Hectorite C.I. Basic Black 2 conjugate, Saponite Basic Blue B7 C.I. 42595 conjugate, Saponite Basic Blue B9 C.I. 52015 conjugate, Saponite Basic Violet V3 C.I. 42555 conjugate, Saponite Basic Green G1 C.I. 42040 conjugate, Saponite Basic Red R1 C.I. 45160 conjugate, Saponite C.I. Basic Black 2 conjugate and mixtures thereof.

The hueing agent may be incorporated into the detergent composition as part of a reaction mixture which is the result of the organic synthesis for a dye molecule, with optional purification step(s). Such reaction mixtures generally comprise the dye molecule itself and in addition may comprise un-reacted starting materials and/or by-products of the organic synthesis route.

Suitable polymeric hueing agents may be alkoxylated. As with all such alkoxylated compounds, the organic synthesis may produce a mixture of molecules having different degrees of alkoxylation. Such mixtures may be used directly to provide the hueing agent, or may undergo a purification step to increase the proportion of the target molecule. Suitable pigments include pigments selected from the group consisting of flavanthrone, indanthrone, chlorinated indanthrone containing from 1 to 4 chlorine atoms, pyranthrone, dichloropyranthrone, monobromodichloropyranthrone, dibromodichloropyranthrone, tetrabromopyranthrone, perylene-3,4,9,10-tetracarboxylic acid diimide, wherein the imide groups may be unsubstituted or substituted by C₁-C₃-alkyl or a phenyl or heterocyclic radical, and wherein the phenyl and heterocyclic radicals may additionally carry substituents which do not confer solubility in water, anthrapyrimidinecarboxylic acid amides, violanthrone, isoviolanthrone, dioxazine pigments, copper phthalocyanine which may contain up to 2 chlorine atoms per molecule, polychloro-copper phthalocyanine or polybromochloro-copper phthalocyanine containing up to 14 bromine atoms per molecule and mixtures thereof. In another aspect, suitable pigments include pigments selected from the group consisting of Ultramarine Blue (C.I. Pigment Blue 29), Ultramarine Violet (C.I. Pigment Violet 15), Monastral Blue and mixtures thereof.

The aforementioned fabric hueing agents can be used in combination (any mixture of fabric hueing agents can be used).

Deposition Aid—In one aspect, the fabric treatment composition may comprise from about 0.01% to about 10%, from about 0.05 to about 5%, or from about 0.15 to about 3% of a deposition aid. In one aspect, the deposition aid may be a cationic or amphoteric polymer. In another aspect, the deposition aid may be a cationic polymer. Cationic polymers in general and their method of manufacture are known in the literature. In one aspect, the cationic polymer may have a cationic charge density of from about 0.005 to about 23 meq/g, from about 0.01 to about 12 meq/g, or from about 0.1 to about 7 meq/g, at the pH of the composition. For amine-containing polymers, wherein the charge density depends on the pH of the composition, charge density is measured at the intended use pH of the product. Such pH will generally range from about 2 to about 11, more generally from about 2.5 to about 9.5. Charge density is calculated by dividing the number of net charges per repeating unit by the molecular weight of the repeating unit. The positive charges may be located on the backbone of the polymers and/or the side chains of polymers.

In another aspect, the deposition aid may comprise a cationic acrylic based polymer. In a further aspect, the deposition aid may comprise a cationic polyacrylamide. In another aspect, the deposition aid may comprise a polymer comprising polyacrylamide and polymethacrylamidopropyl trimethylammonium cation. In another aspect, the deposition aid may comprise poly(acrylamide-N-dimethyl aminoethyl acrylate) and its quaternized derivatives.

In another aspect, the deposition aid may be selected from the group consisting of cationic or amphoteric polysaccharides. In one aspect, the deposition aid may be selected from the group consisting of cationic and amphoteric cellulose ethers, cationic or amphoteric galactomannan, cationic guar gum, cationic or amphoteric starch, and combinations thereof

Another group of suitable cationic polymers may include alkylamine-epichlorohydrin polymers which are reaction products of amines and oligoamines with epichlorohydrin. Another group of suitable synthetic cationic polymers may include polyamidoamine-epichlorohydrin (PAE) resins of polyalkylenepolyamine with polycarboxylic acid. The most common PAE resins are the condensation products of diethylenetriamine with adipic acid followed by a subsequent reaction with epichlorohydrin.

The weight-average molecular weight of the polymer may be from about 500 Daltons to about 5,000,000 Daltons, or from about 1,000 Daltons to about 2,000,000 Daltons, or from about 2,500 Daltons to about 1,500,000 Daltons, as determined by size exclusion chromatography relative to polyethylene oxide standards with RI detection. In one aspect, the MW of the cationic polymer may be from about 500 Daltons to about 37,500 Daltons.

Surfactants: Surfactants utilized can be of the anionic, nonionic, zwitterionic, ampholytic or cationic type or can comprise compatible mixtures of these types. Anionic and nonionic surfactants are typically employed if the fabric care product is a laundry detergent. On the other hand, cationic surfactants are typically employed if the fabric care product is a fabric softener.

In addition to the anionic surfactant, the fabric care compositions of the present invention may further contain a nonionic surfactant. The compositions of the present invention can contain up to about 30%, alternatively from about 0.01% to about 20%, more alternatively from about 0.1% to about 10%, by weight of the composition, of a nonionic surfactant. In one embodiment, the nonionic surfactant may comprise an ethoxylated nonionic surfactant. Suitable for use herein are the ethoxylated alcohols and ethoxylated alkyl phenols of the formula R(OC₂H₄)n OH, wherein R is selected from the group consisting of aliphatic hydrocarbon radicals containing from about 8 to about 20 carbon atoms and alkyl phenyl radicals in which the alkyl groups contain from about 8 to about 12 carbon atoms, and the average value of n is from about 5 to about 15.

Suitable nonionic surfactants are those of the formula R1(OC₂H₄)nOH, wherein R1 is a C₁₀-C₁₆ alkyl group or a C₈-C₁₂ alkyl phenyl group, and n is from 3 to about 80. In one aspect, particularly useful materials are condensation products of C₉-C₁₅ alcohols with from about 5 to about 20 moles of ethylene oxide per mole of alcohol.

The fabric care compositions of the present invention may contain up to about 30%, alternatively from about 0.01% to about 20%, more alternatively from about 0.1% to about 20%, by weight of the composition, of a cationic surfactant. For the purposes of the present invention, cationic surfactants include those which can deliver fabric care benefits. Non-limiting examples of useful cationic surfactants include: fatty amines; quaternary ammonium surfactants; and imidazoline quat materials.

Non-limiting examples of fabric softening actives are N, N-bis(stearoyl-oxy-ethyl) N,N-dimethyl ammonium chloride, N,N-bis(tallowoyl-oxy-ethyl) N,N-dimethyl ammonium chloride, N,N-bis(stearoyl-oxy-ethyl) N-(2 hydroxyethyl) N-methyl ammonium methylsulfate; 1, 2 di (stearoyl-oxy) 3 trimethyl ammoniumpropane chloride; dialkylenedimethylammonium salts such as dicanoladimethylammonium chloride, di(hard)tallowdimethylammonium chloride dicanoladimethylammonium methylsulfate; 1-methyl-1-stearoylamidoethyl-2-stearoylimidazolinium methylsulfate; 1-tallowylamidoethyl-2-tallowylimidazoline; N,N″-dialkyldiethylenetriamine; the reaction product of N-(2-hydroxyethyl)-1,2-ethylenediamine or N-(2-hydroxyisopropyl)-1,2-ethylenediamine with glycolic acid, esterified with fatty acid, where the fatty acid is (hydrogenated) tallow fatty acid, palm fatty acid, hydrogenated palm fatty acid, oleic acid, rapeseed fatty acid, hydrogenated rapeseed fatty acid; polyglycerol esters (PGEs), oily sugar derivatives, and wax emulsions and a mixture of the above.

It will be understood that combinations of softener actives disclosed above are suitable for use herein.

Builders—The compositions may also contain from about 0.1% to 80% by weight of a builder. Compositions in liquid form generally contain from about 1% to 10% by weight of the builder component. Compositions in granular form generally contain from about 1% to 50% by weight of the builder component. Detergent builders are well known in the art and can contain, for example, phosphate salts as well as various organic and inorganic nonphosphorus builders. Water-soluble, nonphosphorus organic builders useful herein include the various alkali metal, ammonium and substituted ammonium polyacetates, carboxylates, polycarboxylates and polyhydroxy sulfonates. Examples of polyacetate and polycarboxylate builders are the sodium, potassium, lithium, ammonium and substituted ammonium salts of ethylene diamine tetraacetic acid, nitrilotriacetic acid, oxydisuccinic acid, mellitic acid, benzene polycarboxylic acids, and citric acid. Other polycarboxylate builders are the oxydisuccinates and the ether carboxylate builder compositions comprising a combination of tartrate monosuccinate and tartrate disuccinate. Builders for use in liquid detergents include citric acid. Suitable nonphosphorus, inorganic builders include the silicates, aluminosilicates, borates and carbonates, such as sodium and potassium carbonate, bicarbonate, sesquicarbonate, tetraborate decahydrate, and silicates having a weight ratio of SiO2 to alkali metal oxide of from about 0.5 to about 4.0, or from about 1.0 to about 2.4. Also useful are aluminosilicates including zeolites.

Dispersants—The compositions may contain from about 0.1%, to about 10%, by weight of dispersants Suitable water-soluble organic materials are the homo- or co-polymeric acids or their salts, in which the polycarboxylic acid may contain at least two carboxyl radicals separated from each other by not more than two carbon atoms. The dispersants may also be alkoxylated derivatives of polyamines, and/or quaternized derivatives.

Enzymes—The compositions may contain one or more detergent enzymes which provide cleaning performance and/or fabric care benefits. Examples of suitable enzymes include hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination may be a cocktail of conventional applicable enzymes like protease, lipase, cutinase and/or cellulase in conjunction with amylase. Enzymes can be used at their art-taught levels, for example at levels recommended by suppliers such as Novozymes and DuPont's Genencor Division. Typical levels in the compositions are from about 0.0001% to about 5%. When enzymes are present, they can be used at very low levels, e.g., from about 0.001% or lower; or they can be used in heavier-duty laundry detergent formulations at higher levels, e.g., about 0.1% and higher. In accordance with a preference of some consumers for “non-biological” detergents, the compositions may be either or both enzyme-containing and enzyme-free.

Dye Transfer Inhibiting Agents—The compositions may also include from about 0.0001%, from about 0.01%, from about 0.05% by weight of the compositions to about 10%, about 2%, or even about 1% by weight of the compositions of one or more dye transfer inhibiting agents such as polyvinylpyrrolidone polymers, polyamine N-oxide polymers, copolymers of N-vinylpyrrolidone and N-vinylimidazole, polyvinyloxazolidones and polyvinylimidazoles or mixtures thereof.

Chelant—The compositions may contain less than about 5%, or from about 0.01% to about 3% of a chelant such as citrates; nitrogen-containing, P-free aminocarboxylates such as EDDS, EDTA and DTPA; aminophosphonates such as diethylenetriamine pentamethylenephosphonic acid and, ethylenediamine tetramethylenephosphonic acid; nitrogen-free phosphonates e.g., HEDP; and nitrogen or oxygen containing, P-free carboxylate-free chelants such as compounds of the general class of certain macrocyclic N-ligands such as those known for use in bleach catalyst systems.

Brighteners—The compositions may also comprise a brightener (also referred to as “optical brightener”) and may include any compound that exhibits fluorescence, including compounds that absorb UV light and reemit as “blue” visible light. Non-limiting examples of useful brighteners include: derivatives of stilbene or 4,4′-diaminostilbene, biphenyl, five-membered heterocycles such as triazoles, pyrazolines, oxazoles, imidiazoles, etc., or six-membered heterocycles (coumarins, naphthalamide, s-triazine, etc.). Cationic, anionic, nonionic, amphoteric and zwitterionic brighteners can be used. Suitable brighteners include those commercially marketed under the trade name Tinopal-UNPA-GX® by Ciba Specialty Chemicals Corporation (High Point, N.C.).

Bleach system—Bleach systems suitable for use herein contain one or more bleaching agents. Non-limiting examples of suitable bleaching agents include catalytic metal complexes; activated peroxygen sources; bleach activators; bleach boosters; photobleaches; bleaching enzymes; free radical initiators; H₂O₂; hypohalite bleaches; peroxygen sources, including perborate and/or percarbonate and combinations thereof. Suitable bleach activators include perhydrolyzable esters and perhydrolyzable imides such as, tetraacetyl ethylene diamine, octanoylcaprolactam, benzoyloxybenzenesulphonate, nonanoyloxybenzene [symbol] sulphonate, benzoylvalerolactam, dodecanoyloxybenzenesulphonate. Other bleaching agents include metal complexes of transitional metals with ligands of defined stability constants.

Structurant/Thickeners

1 Di-Benzylidene Polyol Acetal Derivative

The fluid detergent composition may comprise from about 0.01% to about 1% by weight of a dibenzylidene polyol acetal derivative (DBPA), or from about 0.05% to about 0.8%, or from about 0.1% to about 0.6%, or even from about 0.3% to about 0.5%. Non-limiting examples of suitable DBPA molecules are disclosed in U.S. 61/167,604. In one aspect, the DBPA derivative may comprise a dibenzylidene sorbitol acetal derivative (DBS). Said DBS derivative may be selected from the group consisting of: 1,3:2,4-dibenzylidene sorbitol; 1,3:2,4-di(p-methylbenzylidene) sorbitol; 1,3:2,4-di(p-chlorobenzylidene) sorbitol; 1,3:2,4-di(2,4-dimethyldibenzylidene) sorbitol; 1,3:2,4-di(p-ethylbenzylidene) sorbitol; and 1,3:2,4-di(3,4-dimethyldibenzylidene) sorbitol or mixtures thereof. These and other suitable DBS derivatives are disclosed in U.S. Pat. No. 6,102,999, column 2 line 43 to column 3 line 65.

2 Bacterial Cellulose

The fluid detergent composition may also comprise from about 0.005% to about 1% by weight of a bacterial cellulose network. The term “bacterial cellulose” encompasses any type of cellulose produced via fermentation of a bacteria of the genus Acetobacter such as CELLULON® by CPKelco U.S. and includes materials referred to popularly as microfibrillated cellulose, reticulated bacterial cellulose, and the like. Some examples of suitable bacterial cellulose can be found in U.S. Pat. No. 6,967,027; U.S. Pat. No. 5,207,826; U.S. Pat. No. 4,487,634; U.S. Pat. No. 4,373,702; U.S. Pat. No. 4,863,565 and US 2007/0027108. In one aspect, said fibres have cross sectional dimensions of 1.6 nm to 3.2 nm by 5.8 nm to 133 nm. Additionally, the bacterial cellulose fibres have an average microfibre length of at least about 100 nm, or from about 100 to about 1,500 nm. In one aspect, the bacterial cellulose microfibres have an aspect ratio, meaning the average microfibre length divided by the widest cross sectional microfibre width, of from about 100:1 to about 400:1, or even from about 200:1 to about 300:1.

3 Coated Bacterial Cellulose

In one aspect, the bacterial cellulose is at least partially coated with a polymeric thickener. The at least partially coated bacterial cellulose can be prepared in accordance with the methods disclosed in US 2007/0027108 paragraphs 8 to 19. In one aspect the at least partially coated bacterial cellulose comprises from about 0.1% to about 5%, or even from about 0.5% to about 3%, by weight of bacterial cellulose; and from about 10% to about 90% by weight of the polymeric thickener. Suitable bacterial cellulose may include the bacterial cellulose described above and suitable polymeric thickeners include: carboxymethylcellulose, cationic hydroxymethylcellulose, and mixtures thereof.

4 Cellulose Fibers Non-Bacterial Cellulose Derived

In one aspect, the composition may further comprise from about 0.01 to about 5% by weight of the composition of a cellulosic fiber. Said cellulosic fiber may be extracted from vegetables, fruits or wood. Commercially available examples are Avicel® from FMC, Citri-Fi from Fiberstar or Betafib from Cosun.

5 Non-Polymeric Crystalline Hydroxyl-Functional Materials

In one aspect, the composition may further comprise from about 0.01 to about 1% by weight of the composition of a non-polymeric crystalline, hydroxyl functional structurant. Said non-polymeric crystalline, hydroxyl functional structurants generally may comprise a crystallizable glyceride which can be pre-emulsified to aid dispersion into the final fluid detergent composition. In one aspect, crystallizable glycerides may include hydrogenated castor oil or “HCO” or derivatives thereof, provided that it is capable of crystallizing in the liquid detergent composition.

6 Polymeric Structuring Agents

Fluid detergent compositions of the present invention may comprise from about 0.01% to about 5% by weight of a naturally derived and/or synthetic polymeric structurant. Examples of naturally derived polymeric structurants of use in the present invention include: hydroxyethyl cellulose, hydrophobically modified hydroxyethyl cellulose, carboxymethyl cellulose, polysaccharide derivatives and mixtures thereof. Suitable polysaccharide derivatives include: pectine, alginate, arabinogalactan (gum Arabic), carrageenan, gellan gum, xanthan gum, guar gum and mixtures thereof. Examples of synthetic polymeric structurants of use in the present invention include: polycarboxylates, polyacrylates, hydrophobically modified ethoxylated urethanes, hydrophobically modified non-ionic polyols and mixtures thereof. In one aspect, said polycarboxylate polymer is a polyacrylate, polymethacrylate or mixtures thereof. In another aspect, the polyacrylate is a copolymer of unsaturated mono- or di-carbonic acid and C₁-C₃₀ alkyl ester of the (meth)acrylic acid. Said copolymers are available from Noveon inc under the tradename Carbopol Aqua 30.

7 Di-Amido-Gellants

In one aspect, the external structuring system may comprise a di-amido gellant having a molecular weight from about 150 g/mol to about 1,500 g/mol, or even from about 500 g/mol to about 900 g/mol. Such di-amido gellants may comprise at least two nitrogen atoms, wherein at least two of said nitrogen atoms form amido functional substitution groups. In one aspect, the amido groups are different. In another aspect, the amido functional groups are the same. The di-amido gellant has the following formula:

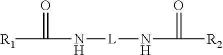

wherein:

R₁ and R₂ is an amino functional end-group, or even amido functional end-group, in one aspect R₁ and R₂ may comprise a pH-tunable group, wherein the pH tunable amido-gellant may have a pKa of from about 1 to about 30, or even from about 2 to about 10. In one aspect, the pH tunable group may comprise a pyridine. In one aspect, R₁ and R₂ may be different. In another aspect, may be the same.

L is a linking moeity of molecular weight from 14 to 500 g/mol. In one aspect, L may comprise a carbon chain comprising between 2 and 20 carbon atoms. In another aspect, L may comprise a pH-tunable group. In one aspect, the pH tunable group is a secondary amine.

In one aspect, at least one of R₁, R₂ or L may comprise a pH-tunable group.

Non-limiting examples of di-amido gellants are:
N,N′-(2S,2′S)-1,1′-(dodecane-1,12-diylbis(azanediyl))bis(3-methyl-1-oxobutane-2,1-diyl)diisonicotinamide

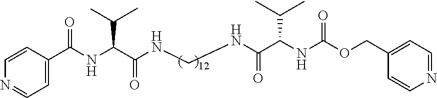

dibenzyl (2S,2′S)-1,1′-(propane-1,3-diylbis(azanediyl))bis(3-methyl-1-oxobutane-2,1-diyl)dicarbamate

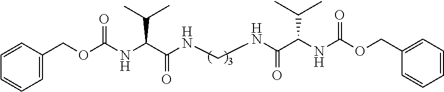

dibenzyl (2S,2′S)-1,1′-(dodecane-1,12-diylbis(azanediyl))bis(1-oxo-3-phenylpropane-2,1-diyl)dicarbamate

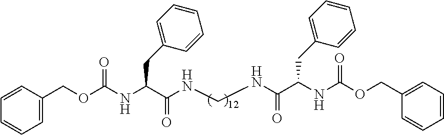

Silicones—Suitable silicones comprise Si—O moieties and may be selected from (a) non-functionalized siloxane polymers, (b) functionalized siloxane polymers, and combinations thereof. The molecular weight of the organosilicone is usually indicated by the reference to the viscosity of the material. In one aspect, the organosilicones may comprise a viscosity of from about 10 to about 2,000,000 centistokes at 25° C. In another aspect, suitable organosilicones may have a viscosity of from about 10 to about 800,000 centistokes at 25° C.

Suitable organosilicones may be linear, branched or cross-linked.

In one aspect, the organosilicone may comprise a cyclic silicone. The cyclic silicone may comprise a cyclomethicone of the formula [(CH₃)₂SiO]ₙ where n is an integer that may range from about 3 to about 7, or from about 5 to about 6.

In one aspect, the organosilicone may comprise a functionalized siloxane polymer. Functionalized siloxane polymers may comprise one or more functional moieties selected from the group consisting of amino, amido, alkoxy, hydroxy, polyether, carboxy, hydride, mercapto, sulfate phosphate, and/or quaternary ammonium moieties. These moieties may be attached directly to the siloxane backbone through a bivalent alkylene radical, (i.e., “pendant”) or may be part of the backbone. Suitable functionalized siloxane polymers include materials selected from the group consisting of aminosilicones, amidosilicones, silicone polyethers, silicone-urethane polymers, quaternary ABn silicones, amino ABn silicones, and combinations thereof.

In one aspect, the functionalized siloxane polymer may comprise a silicone polyether, also referred to as “dimethicone copolyol.” In general, silicone polyethers comprise a polydimethylsiloxane backbone with one or more polyoxyalkylene chains. The polyoxyalkylene moieties may be incorporated in the polymer as pendent chains or as terminal blocks. In another aspect, the functionalized siloxane polymer may comprise an aminosilicone.

In one aspect, the organosilicone may comprise amine ABn silicones and quat ABn silicones. Such organosilicones are generally produced by reacting a diamine with an epoxide.

In another aspect, the functionalized siloxane polymer may comprise silicone-urethanes. These are commercially available from Wacker Silicones under the trade name SLM-21200®.

Perfume: The optional perfume component may comprise a component selected from the group consisting of
(1) a perfume microcapsule, or a moisture-activated perfume microcapsule, comprising a perfume carrier and an encapsulated perfume composition, wherein said perfume carrier may be selected from the group consisting of cyclodextrins, starch microcapsules, porous carrier microcapsules, and mixtures thereof; and wherein said encapsulated perfume composition may comprise low volatile perfume ingredients, high volatile perfume ingredients, and mixtures thereof;
(2) a pro-perfume;
(3) a low odor detection threshold perfume ingredients, wherein said low odor detection threshold perfume ingredients may comprise less than about 25%, by weight of the total neat perfume composition; and
(4) mixtures thereof; and

Porous Carrier Microcapsule—A portion of the perfume composition can also be absorbed onto and/or into a porous carrier, such as zeolites or clays, to form perfume porous carrier microcapsules in order to reduce the amount of free perfume in the multiple use fabric conditioning composition.

Pro-perfume—The perfume composition may additionally include a pro-perfume. Pro-perfumes may comprise nonvolatile materials that release or convert to a perfume material as a result of, e.g., simple hydrolysis, or may be pH-change-triggered pro-perfumes (e.g. triggered by a pH drop) or may be enzymatically releasable pro-perfumes, or light-triggered pro-perfumes. The pro-perfumes may exhibit varying release rates depending upon the pro-perfume chosen.

Method of Use

A method of reducing malodor comprising

a) optionally, washing rinsing and or drying a situs;

b) treating a situs with any cleaning and/or treatment product disclosed herein; and

c) optionally, washing rinsing and or drying said situs

wherein said drying is passive and/or active drying is disclosed.

Preferably said situs is sufficiently treated to provide said situs with, based on total situs weight, from about 0.001 ppm to about 100 ppm of a tannin.

Treatment Liquor

A treatment liquor comprising based on total treatment liquor weight, from about 0.001 ppm to about 500 ppm, from about 0.001 ppm to about 300 ppm, more preferably from about 0.01 ppm to about 100 ppm of a tannin is disclosed.

Tannin Concentration Test Method

UV-Spectroscopy is used to determine the concentration of tannins in a liquid test composition, or in a solid or unit dose test composition, or in the wash water liquor of a test composition. One suitable UV-spectrophotometer instrument is the model UV1800, manufactured by Shimadzu Corporation in Kyoto, Japan. Samples of the test composition material are prepared in order to generate a liquid test sample which is the solution that is measured spectroscopically. The UV-spectroscopy analysis is conducted in transmission mode, with an optical path length of 0.4 cm, and the absorbance measured at a wavelength of 280 nm. Two standard reference materials of known tannins are prepared in dilution series in order to create two internal-spike calibration curves for determining tannin concentration. These two standard reference material tannins are: tannic acid and (-)-epigallocatechin gallate, (available as catalogue numbers 16201 and 93894, respectively, from Sigma Aldrich Co. LLC in St. Louis, Mo., USA).

Samples of solid or unit dose test compositions are first dissolved in a known mass of deionized water that is sufficient to fully dissolve the solid composition at 25° C. Samples of solid or unit dose test compositions are initially dissolved in an equal mass of deionized water, to create a 50% (wt/wt) solution. Agitation and heating to a temperature of 25° C. may be required to achieve dissolution within 30 mins. If additional water is required to fully dissolve the solid composition, then one or more additional masses of deionized water are added, with each sequential addition having the same mass as the first addition of water. A minimum number of water additions are used in order to achieve full dissolution of the composition. The resultant solution is the liquid test sample to be analysed for the solid or unit dose composition being tested.

Samples of liquid test compositions are diluted with an equal volume of deionized water to create a 50% (v/v) solution. The resultant solution is the liquid test sample to be analysed for the fluid composition being tested.

Samples of wash water liquor are generated according to the procedure below.

Preparation of Tannin Solvent

Tannin solvent is prepared by making a 1:1:1 solution water:ethanol:ethylene glycol. A glass jar is tared on a scale and 25 mg of water is added to the jar. The scale is then re-zeroed and 25 g of ethanol is added to the jar containing water. The scale is re-zeroed and 25 g of ethylene glycol is added to the water:ethanol mixture. The jar is then sealed with a lid and shaken to mix.

Preparation of Tannin Working Solution Tannin working solution is prepared by making a 2% mixture of tannin material in Tannin Solvent. A glass jar is tared on a scale and 0.4 g of tannin extract is added to the jar.

Next, Tannin Solvent is added to the jar until the measured weight reaches 20 g. The jar is sealed with a lid and placed in a ultrasonicator where the mixture is sonicated for 30 minutes.

Preparation of Liquid Laundry Detergent+Tannin

A mixture of liquid laundry detergent containing 0.2% Tannin Working Solution is prepared by taring a glass jar on a scale and adding 0.2 g of Tannin Working Solution to the jar. Liquid Laundry Detergent is then added to the jar until the measured weight reaches 100 g.

Preparation of Wash Liquor

Prepare a mixture of water containing 0.095% liquid laundry detergent comprising tannin. A pail is tared on a scale and 7.2 g of liquid laundry detergent+tannin is added to the pail. The scale is then re-zeroed and 7.57 kg of 32° C., 7 gpg water is added to the pail. The Wash liquor is then blended to mix by using and overhead mixer with a pitched impeller to stir.

The resultant solution is the liquid test sample to be analysed to determine tannin concentration in the wash water liquor of the composition being tested.

The two internal calibration curves are created by generating two separate tannin-spiked sample solutions, one from each of the two standard reference tannins. Each tannin-spiked sample solution comprises a final concentration of 1% standard reference tannin (wt/v), in an aliquot of liquid test sample prepared according to the instructions given herein. Each of the resulting two tannin-spiked sample solutions is then subsequently used to create a dilution series.

A dilution series is created from each prepared liquid test sample or tannin-spiked sample solution. Each dilution series is prepared with buffer and deionized water to yield a series of five dilution solutions each having a different final concentration. The final concentration of liquid test solution or tannin-spiked sample solution (as appropriate) in each of the five solutions in the dilution series is as follows: 100 ppm; 50 ppm; 25 ppm; 10 ppm; and 0 ppm. Each solution in the dilution series has a final volume of 1 mL and comprises 990 uL of 20 mM MOPS (3-(N-morpholino)propanesulfonic acid) buffer at pH 7.1. The remaining volumes of deionized water, and either liquid test sample or tannin stock solution, are adjusted as needed in order to achieve the five specified concentrations.

Each material being tested yields a total of 15 fluids, resulting from 5 dilutions in 3 series (i.e., liquid test sample; the first tannin-spiked reference sample; and the second tannin-spiked reference sample). Each of the 15 fluids is measured in the UV-spectrophotometer and the absorbance value at 280 nm is measured three times. The average of the three measurements is the absorbance value recorded for that fluid.

The measured absorbance values from the three series are plotted on a graph and linear line fit to each of the three data series. The slopes of the lines from the two tannin-spiked reference samples are then compared to the slope of the line from the liquid test sample. The tannin-spike reference sample having a slope most similar to the liquid test sample slope is identified and selected for further analysis. The least similar slope is discarded. Of the most similar tannin-spiked reference line, if the range of absorbance values does not overlap with the range of absorbance values of the liquid test sample, then an additional calibration dilution series is prepared and measured. This new dilution series is prepared at modified concentrations such that the new linear calibration curve overlaps with the linear line fit through the absorbance values from the liquid test sample series. The point at which the two lines intersect indicates the concentration of tannin in the liquid test sample, and is used to back calculate the concentration of tannin present in the original test material.

### EXAMPLES

### I. Synthesis Examples

Bark pine was air dried. After wiley milling it was submitted to extraction in 2% Na2CO3- in a 1:5 liquor. The mixture was refluxed during two hours. The solid residue was filtered off and the solvent removed by rotary evaporation after careful neutralization with HCl.

### Examples of Use

Granular laundry detergent compositions for hand washing or washing machines, typically top-loading washing machines.

| | A | B | C | D | E | F |
|---|---|---|---|---|---|---|
| | (wt %) | (wt %) | (wt %) | (wt %) | (wt %) | (wt %) |
| Linear alkylbenzenesulfonate | 20 | 22 | 20 | 15 | 19.5 | 20 |
| C₁₂₋₁₄ Dimethylhydroxyethyl | 0.7 | 0.2 | 1 | 0.6 | 0.0 | 0 |
| ammonium chloride | | | | | | |
| AE3S | 0.9 | 1 | 0.9 | 0.0 | 0.4 | 0.9 |
| AE7 | 0.0 | 0.0 | 0.0 | 1 | 0.1 | 3 |
| Sodium tripolyphosphate | 5 | 0.0 | 4 | 9 | 2 | 0.0 |
| Zeolite A | 0.0 | 1 | 0.0 | 1 | 4 | 1 |
| 1.6R Silicate (SiO₂:Na₂O at | 7 | 5 | 2 | 3 | 3 | 5 |
| ratio 1.6:1) | | | | | | |
| Sodium carbonate | 25 | 20 | 25 | 17 | 18 | 19 |
| Polyacrylate MW 4500 | 1 | 0.6 | 1 | 1 | 1.5 | 1 |
| Random graft copolymer¹ | 0.1 | 0.2 | 0.0 | 0.0 | 0.05 | 0.0 |
| Carboxymethyl cellulose | 1 | 0.3 | 1 | 1 | 1 | 1 |
| Stainzyme ® (20 mg active/g) | 0.1 | 0.2 | 0.1 | 0.2 | 0.1 | 0.1 |
| Protease (Savinase ®, 32.89 mg | 0.1 | 0.1 | 0.1 | 0.1 | | 0.1 |
| active/g) | | | | | | |
| Amylase - Natalase ® (8.65 mg | 0.1 | 0.0 | 0.1 | 0.0 | 0.1 | 0.1 |
| active/g) | | | | | | |
| Lipase - Lipex ® (18 mg active/ | 0.03 | 0.07 | 0.3 | 0.1 | 0.07 | 0.4 |
| g) | | | | | | |
| Fluorescent Brightener 1 | 0.06 | 0.0 | 0.06 | 0.18 | 0.06 | 0.06 |
| Fluorescent Brightener 2 | 0.1 | 0.06 | 0.1 | 0.0 | 0.1 | 0.1 |
| DTPA | 0.6 | 0.8 | 0.6 | 0.25 | 0.6 | 0.6 |
| MgSO₄ | 1 | 1 | 1 | 0.5 | 1 | 1 |
| Sodium Percarbonate | 0.0 | 5.2 | 0.1 | 0.0 | 0.0 | 0.0 |
| Sodium Perborate | 4.4 | 0.0 | 3.85 | 2.09 | 0.78 | 3.63 |
| Monohydrate | | | | | | |
| NOBS | 1.9 | 0.0 | 1.66 | 0.0 | 0.33 | 0.75 |
| TAED | 0.58 | 1.2 | 0.51 | 0.0 | 0.015 | 0.28 |
| Sulphonated zinc | 0.0030 | 0.0 | 0.0012 | 0.0030 | 0.0021 | 0.0 |
| phthalocyanine | | | | | | |
| S-ACMC | 0.1 | 0.0 | 0.0 | 0.0 | 0.06 | 0.0 |
| Direct Violet Dye (DV9 or | 0.0 | 0.0 | 0.0003 | 0.0001 | 0.0001 | 0.0 |
| DV99 or DV66) | | | | | | |
| Additional Neat Perfume | 0.5 | 0.5 | 0.5 | 0.5 | 0.5 | 0.5 |
| Tannin* | 0.07 | 0.004 | 0.0001 | 0.05 | 1 | 0.08 |

| | |
|---|---|
| Sulfate/Moisture | Balance |

### II.2 Granular Laundry Detergent Compositions Typically for Front-Loading Automatic Washing Machines. The Typical pH is about 10

| | A | B | C | D | E | F |
|---|---|---|---|---|---|---|
| | (wt %) | (wt %) | (wt %) | (wt %) | (wt %) | (wt %) |
| Linear alkylbenzenesulfonate | 8 | 7.1 | 7 | 6.5 | 7.5 | 7.5 |
| AE3S | 0 | 4.8 | 1.0 | 5.2 | 4 | 4 |
| C12-14 Alkylsulfate | 1 | 0 | 1 | 0 | 0 | 0 |
| AE7 | 2.2 | 0 | 2.2 | 0 | 0 | 0 |
| C₁₀₋₁₂ Dimethyl | 0.75 | 0.94 | 0.98 | 0.98 | 0 | 0 |
| hydroxyethylammonium chloride | | | | | | |
| Crystalline layered silicate (—Na₂Si₂O₅) | 4.1 | 0 | 4.8 | 0 | 0 | 0 |
| Zeolite A | 5 | 0 | 5 | 0 | 2 | 2 |
| Citric Acid | 3 | 5 | 3 | 4 | 2.5 | 3 |
| Sodium Carbonate | 15 | 20 | 14 | 20 | 23 | 23 |
| Silicate 2R (SiO₂:Na₂O at ratio 2:1) | 0.08 | 0 | 0.11 | 0 | 0 | 0 |
| Soil release agent | 0.75 | 0.72 | 0.71 | 0.72 | 0 | 0 |
| Acrylic Acid/Maleic Acid | 1.1 | 3.7 | 1.0 | 3.7 | 2.6 | 3.8 |
| Copolymer | | | | | | |
| Carboxymethylcellulose | 0.15 | 1.4 | 0.2 | 1.4 | 1 | 0.5 |
| Protease - Purafect ® (84 mg | 0.2 | 0.2 | 0.3 | 0.15 | 0.12 | 0.13 |
| active/g) | | | | | | |
| Amylase - Stainzyme Plus ® (20 mg | 0.2 | 0.15 | 0.2 | 0.3 | 0.15 | 0.15 |
| active/g) | | | | | | |
| Lipase - Lipex ® (18.00 mg active/g) | 0.05 | 0.15 | 0.1 | 0 | 0 | 0 |
| Amylase - Natalase ® (8.65 mg | 0.1 | 0.2 | 0 | 0 | 0.15 | 0.15 |
| active/g) | | | | | | |
| Cellulase - Celluclean ™ (15.6 mg | 0 | 0 | 0 | 0 | 0.1 | 0.1 |
| active/g) | | | | | | |
| TAED | 3.6 | 4.0 | 3.6 | 4.0 | 2.2 | 1.4 |
| Percarbonate | 13 | 13.2 | 13 | 13.2 | 16 | 14 |
| Na salt of Ethylenediamine-N,N′- | 0.2 | 0.2 | 0.2 | 0.2 | 0.2 | 0.2 |
| disuccinic acid, (S,S) isomer (EDDS) | | | | | | |
| Hydroxyethane di phosphonate | 0.2 | 0.2 | 0.2 | 0.2 | 0.2 | 0.2 |
| (HEDP) | | | | | | |
| MgSO₄ | 0.42 | 0.42 | 0.42 | 0.42 | 0.4 | 0.4 |
| Perfume | 0.5 | 0.6 | 0.5 | 0.6 | 0.6 | 0.6 |
| Suds suppressor agglomerate | 0.05 | 0.1 | 0.05 | 0.1 | 0.06 | 0.05 |
| Soap | 0.45 | 0.45 | 0.45 | 0.45 | 0 | 0 |
| Sulphonated zinc phthalocyanine | 0.0007 | 0.0012 | 0.0007 | 0 | 0 | 0 |
| (active) | | | | | | |
| S-ACMC | 0.01 | 0.01 | 0 | 0.01 | 0 | 0 |
| Direct Violet 9 (active) | 0 | 0 | 0.0001 | 0.0001 | 0 | 0 |
| Additional Neat Perfume | 0.5 | 0.5 | 0.5 | 0.5 | 0.5 | 0.5 |
| Tannin* | 0.2 | 1.5 | 0.9 | 0.005 | 1.5 | 0.08 |

| | |
|---|---|
| Sulfate/Water & Miscellaneous | Balance |

### II.3 Heavy Duty Liquid Laundry Detergent Compositions

| | A | B | C | D | E | F | G |
|---|---|---|---|---|---|---|---|
| | (wt %) | (wt %) | (wt %) | (wt %) | (wt %) | (wt %) | (wt %) |
| AES C₁₂₋₁₅ alkyl ethoxy (1.8) | 11 | 10 | 4 | 6.32 | 0 | 0 | 0 |
| sulfate | | | | | | | |
| AE3S | 0 | 0 | 0 | 0 | 2.4 | 0 | 0 |
| Linear alkyl benzene | 1.4 | 4 | 8 | 3.3 | 5 | 8 | 19 |
| sulfonate/sulfonic acid | | | | | | | |
| HSAS | 3 | 5.1 | 3 | 0 | 0 | 0 | 0 |
| Sodium formate | 1.6 | 0.09 | 1.2 | 0.04 | 1.6 | 1.2 | 0.2 |
| Sodium hydroxide | 2.3 | 3.8 | 1.7 | 1.9 | 1.7 | 2.5 | 2.3 |
| Monoethanolamine | 1.4 | 1.49 | 1.0 | 0.7 | 0 | 0 | To pH |
| | | | | | | | 8.2 |
| Diethylene glycol | 5.5 | 0.0 | 4.1 | 0.0 | 0 | 0 | 0 |
| AE9 | 0.4 | 0.6 | 0.3 | 0.3 | 0 | 0 | 0 |
| AE8 | 0 | 0 | 0 | 0 | 0 | 0 | 20.0 |
| AE7 | 0 | 0 | 0 | 0 | 2.4 | 6 | 0 |
| Chelant (HEDP) | 0.15 | 0.15 | 0.11 | 0.07 | 0.5 | 0.11 | 0.8 |
| Citric Acid | 2.5 | 3.96 | 1.88 | 1.98 | 0.9 | 2.5 | 0.6 |
| C₁₂₋₁₄ dimethyl Amine Oxide | 0.3 | 0.73 | 0.23 | 0.37 | 0 | 0 | 0 |
| C₁₂₋₁₈ Fatty Acid | 0.8 | 1.9 | 0.6 | 0.99 | 1.2 | 0 | 15.0 |
| 4-formyl-phenylboronic acid | 0 | 0 | 0 | 0 | 0.05 | 0.02 | 0.01 |
| Borax | 1.43 | 1.5 | 1.1 | 0.75 | 0 | 1.07 | 0 |
| Ethanol | 1.54 | 1.77 | 1.15 | 0.89 | 0 | 3 | 7 |
| A compound having the following | 0.1 | 0 | 0 | 0 | 0 | 0 | 2.0 |
| general structure: | | | | | | | |
| bis((C₂H₅O)(C₂H₄O)n)(CH₃)—N⁺—CₓH₂ₓ—N⁺—(CH₃)— | | | | | | | |
| bis((C₂H₅O)(C₂H₄O)n), wherein n = | | | | | | | |
| from 20 to 30, and x = from 3 to | | | | | | | |
| 8, or sulphated or sulphonated | | | | | | | |
| variants thereof | | | | | | | |
| Ethoxylated (EO₁₅) tetraethylene | 0.3 | 0.33 | 0.23 | 0.17 | 0.0 | 0.0 | 0 |
| pentamine | | | | | | | |
| Ethoxylated Polyethylenimine | 0 | 0 | 0 | 0 | 0 | 0 | 0.8 |
| Ethoxylated hexamethylene | 0.8 | 0.81 | 0.6 | 0.4 | 1 | 1 | |
| diamine | | | | | | | |
| 1,2-Propanediol | 0.0 | 6.6 | 0.0 | 3.3 | 0.5 | 2 | 8.0 |
| Fluorescent Brightener | 0.2 | 0.1 | 0.05 | 0.3 | 0.15 | 0.3 | 0.2 |
| Hydrogenated castor oil derivative | 0.1 | 0 | 0 | 0 | 0 | 0 | 0.1 |
| structurant | | | | | | | |
| Perfume | 1.6 | 1.1 | 1.0 | 0.8 | 0.9 | 1.5 | 1.6 |
| Protease (40.6 mg active/g) | 0.8 | 0.6 | 0.7 | 0.9 | 0.7 | 0.6 | 1.5 |
| Mannanase: Mannaway ® (25 mg | 0.07 | 0.05 | 0.045 | 0.06 | 0.04 | 0.045 | 0.1 |
| active/g) | | | | | | | |
| Amylase: Stainzyme ® (15 mg | 0.3 | 0 | 0.3 | 0.1 | 0 | 0.4 | 0.1 |
| active/g) | | | | | | | |
| Amylase: Natalase ® (29 mg | 0 | 0.2 | 0.1 | 0.15 | 0.07 | 0 | 0.1 |
| active/g) | | | | | | | |
| Xyloglucanase (Whitezyme ®, | 0.2 | 0.1 | 0 | 0 | 0.05 | 0.05 | 0.2 |
| 20 mg active/g) | | | | | | | |
| Lipex ® (18 mg active/g) | 0.4 | 0.2 | 0.3 | 0.1 | 0.2 | 0 | 0 |
| Additional Neat Perfume | 0.5 | 0.5 | 0.5 | 0.5 | 0.5 | 0.5 | 0.5 |
| Tannin* | 0.25 | 0.004 | 0.5 | 0.05 | 0.007 | 1.0 | 0.08 |

| | |
|---|---|
| *Water, dyes & minors | Balance |

*Based on total cleaning and/or treatment composition weight, a total of no more than 12% water

### Examples II.4 Unit Dose Compositions

Example of Unit Dose detergents

| | A | B |
|---|---|---|
| C₁₄₋₁₅ alkyl poly ethoxylate (8) | 12 | — |
| C₁₂₋₁₄ alkyl poly ethoxylate (7) | 1 | 14 |
| C₁₂₋₁₄ alkyl poly ethoxylate (3) | 8.4 | 9 |
| sulfate Mono EthanolAmine salt | | |
| Linear Alkylbenzene sulfonic acid | 15 | 16 |
| Citric Acid | 0.6 | 0.5 |
| C₁₂₋₁₈ Fatty Acid | 15 | 17 |
| Enzymes | 1.5 | 1.2 |
| PEI 600 EO20 | 4 | — |
| Diethylene triamine penta methylene | 1.3 | — |
| phosphonic acid or HEDP | | |
| Fluorescent brightener | 0.2 | 0.3 |
| Hydrogenated Castor Oil | 0.2 | 0.2 |
| 1,2 propanediol | 16 | 12 |
| Glycerol | 6.2 | 8.5 |
| Sodium hydroxide | — | 1 |
| Mono Ethanol Amine | 7.9 | 6.1 |
| Dye | Present | Present |
| PDMS | — | 2.7 |
| Potassium sulphite | 0.2 | 0.2 |
| Tannin* | 0.005 | 0.09 |
| Water | Up to 100 p | Up to 100 |

(1)

Raw Materials and Notes for Composition Examples

LAS is linear alkylbenzenesulfonate having an average aliphatic carbon chain length C₉-C₁₅ supplied by Stepan, Northfield, Ill., USA or Huntsman Corp. (HLAS is acid form).

C₁₂₋₁₄ Dimethylhydroxyethyl ammonium chloride, supplied by Clariant GmbH, Germany

AE3S is C₁₂₋₁₅ alkyl ethoxy (3) sulfate supplied by Stepan, Northfield, Ill., USA

AE7 is C₁₂₋₁₅ alcohol ethoxylate, with an average degree of ethoxylation of 7, supplied by Huntsman, Salt Lake City, Utah, USA

AES is C₁₀₋₁₈ alkyl ethoxy sulfate supplied by Shell Chemicals.

AE9 is C₁₂₋₁₃ alcohol ethoxylate, with an average degree of ethoxylation of 9, supplied by Huntsman, Salt Lake City, Utah, USA

HSAS or HC1617HSAS is a mid-branched primary alkyl sulfate with average carbon chain length of about 16-17

Sodium tripolyphosphate is supplied by Rhodia, Paris, France

Zeolite A is supplied by Industrial Zeolite (UK) Ltd, Grays, Essex, UK

1.6R Silicate is supplied by Koma, Nestemica, Czech Republic

Sodium Carbonate is supplied by Solvay, Houston, Tex., USA

Polyacrylate MW 4500 is supplied by BASF, Ludwigshafen, Germany

Carboxymethyl cellulose is Finnfix® V supplied by CP Kelco, Arnhem, Netherlands

Suitable chelants are, for example, diethylenetetraamine pentaacetic acid (DTPA) supplied by Dow Chemical, Midland, Mich., USA or Hydroxyethane di phosphonate (HEDP) supplied by Solutia, St Louis, Mo., USA Bagsvaerd, Denmark

Savinase®, Natalase®, Stainzyme®, Lipex®, Celluclean™, Mannaway® and Whitezyme® are all products of Novozymes, Bagsvaerd, Denmark.

Proteases may be supplied by Genencor International, Palo Alto, Calif., USA (e.g. Purafect Prime®) or by Novozymes, Bagsvaerd, Denmark (e.g. Liquanase®, Coronase®).

Fluorescent Brightener 1 is Tinopal® AMS, Fluorescent Brightener 2 is Tinopal® CBS-X, Sulphonated zinc phthalocyanine and Direct Violet 9 is Pergasol® Violet BN-Z all supplied by Ciba Specialty Chemicals, Basel, Switzerland

Sodium percarbonate supplied by Solvay, Houston, Tex., USA

Sodium perborate is supplied by Degussa, Hanau, Germany

NOBS is sodium nonanoyloxybenzenesulfonate, supplied by Future Fuels, Batesville, USA.

TAED is tetraacetylethylenediamine, supplied under the Peractive® brand name by Clariant GmbH, Sulzbach, Germany

S-ACMC is carboxymethylcellulose conjugated with C.I. Reactive Blue 19, sold by Megazyme, Wicklow, Ireland under the product name AZO-CM-CELLULOSE, product code S-ACMC.

Soil release agent is Repel-o-tex® PF, supplied by Rhodia, Paris, France

Acrylic Acid/Maleic Acid Copolymer is molecular weight 70,000 and acrylate:maleate ratio 70:30, supplied by BASF, Ludwigshafen, Germany

Na salt of Ethylenediamine-N,N′-disuccinic acid, (S,S) isomer (EDDS) is supplied by Octel, Ellesmere Port, UK.

Hydroxyethane di phosphonate (HEDP) is supplied by Dow Chemical, Midland, Mich., USA

Suds suppressor agglomerate is supplied by Dow Corning, Midland, Mich., USA

HSAS is mid-branched alkyl sulfate as disclosed in U.S. Pat. No. 6,020,303 and U.S. Pat. No. 6,060,443

C₁₂₋₁₄ dimethyl Amine Oxide is supplied by Procter & Gamble Chemicals, Cincinnati, USA

Random graft copolymer is a polyvinyl acetate grafted polyethylene oxide copolymer having a polyethylene oxide backbone and multiple polyvinyl acetate side chains. The molecular weight of the polyethylene oxide backbone is about 6000 and the weight ratio of the polyethylene oxide to polyvinyl acetate is about 40:60 and no more than 1 grafting point per 50 ethylene oxide units.

Ethoxylated polyethyleneimine is polyethyleneimine (MW=600) with 20 ethoxylate groups per —NH.

Cationic cellulose polymer is LK400, LR400 and/or JR30M from Amerchol Corporation, Edgewater N.J.

Note: all enzyme levels are expressed as % enzyme raw material

Tannin*=tannin derived from bark pine extract or quebracho extract

Performance Data

The wash experiment was small-scale North America TL (mini-wash). 7.57 L of water with an Liquid detergent in wash concentration of 0.095% (7.2 g dose in 7.57 L of water).

A 90° F. (32° C.) wash cycle for 12 minutes was performed followed by a 2 minute, 60° F. (15.5° C.) rinse cycle. Water hardness for the wash and rinse was 7 gpg. The wash ballast consisted of 250 g of cotton terry cloth (4 cotton terry cloths). 3 malodor tracers (4×4 inch 5050 polycotton swatches) treated with a malodor cocktail were included in the wash experiments. After wash, ballast and malodor tracers were dried in an electric clothes dryer on high/cotton setting for 50 minutes.

| | Malodor intensity |
|---|---|
| Product | (Scale 0-100) |
| Liquid detergent | 50 |
| Liquid detergent + 0.2% of a solution | 30 |
| containing 2% tannin (bark pine extract) | |
| Liquid detergent + 1% of a solution containing | 40 |
| tannin 2% (bark pine extract) | |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cleaning and/or treatment product comprising, based on total cleaning and/or treatment product weight, from about 0.0001% to about 1.5% of a tannin and a cleaning and/or treatment adjunct.

2. The cleaning and/or treatment product of claim 1 wherein said tannins are selected from the group consisting of gallotannins, ellagitannins, condensed tannins, complex tannins and mixtures thereof.

3. The cleaning and/or treatment product according to claim 1 wherein said:
a) gallotannins are extracted from sumac galls, Aleppo oak galls, or sumac leaves;
b) Ellagitannins are extracted from chestnut bark, and chestnut wood;
c) condensed tannins are selected from the group consisting of tannins extracted from bark pine, querbracho, mimosa bark, spruce bark, grape seeds;
d) complex tannins are selected from the group consisting of tannins extracted from persimmon and tea leaves.

4. The cleaning and/or treatment product according to claim 1 wherein said tannin comprises a tannin selected from the group consisting of condensed tannins.

5. The cleaning and/or treatment product according to claim 1 wherein said cleaning and/or treatment adjunct comprises a material selected from the group consisting of surfactants, builders, fatty acids, perfumes, perfume delivery systems, silicone, preferably said material is selected from the group consisting of surfactants, builders, perfumes, perfume delivery systems.

6. A cleaning and/or treatment product according to claim 1 comprising, based on total cleaning and/or treatment product weight, from about 1% to about 97% water.

7. A method of reducing malodor comprising
a) optionally, washing rinsing and or drying a situs;
b) treating a situs with the composition according to claim 1; and
c) optionally, washing rinsing and or drying said situs
wherein said drying is passive and/or active drying.

8. A treatment liquor comprising based on total treatment liquor weight, from about 0.001 ppm to about 500 ppm of a tannin.
